(19) United States
(12) Patent Application Publication
(10) Pub. No.: US 2013/0023256 A1
(43) Pub. Date: Jan. 24, 2013

(54) COMMUNICATION DEVICE AND METHOD USING SAME

(71) Applicant: CHENG-HUANG LU, Shenzhen City (CN)

(72) Inventor: CHENG-HUANG LU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/283,600

(22) Filed: Oct. 28, 2011

(30) Foreign Application Priority Data
Jul. 20, 2011 (CN) 201110203660.6

(51) Int. Cl. H04W 92/00

(52) U.S. Cl. 455/418

(57) ABSTRACT

A communication device and method selectively establishes or cuts off a communication with an external communication device. The communication device stores a number of communication conditions. The communication device acquires identification information of the external communication device. The communication device determines whether the identification information of the external communication device satisfies the communication conditions. The communication device selectively establishes or cuts off the communication with the external communication device according to the determination.

### 1. TECHNICAL FIELD

The disclosure generally relates to communication technologies, and particularly, to a communication device capable of establishing or cutting off a communication with an external communication device according to a number of predetermined communication conditions.

### 2. DESCRIPTION OF RELATED ART

In recent years, due to continuous development of communication technologies, communication devices have been widely used in our daily life and provide much convenience to us. However, inevitably, many users of the communication devices sometimes will receive unwanted calls.

Therefore, it is desirable to provide a communication device and method for using the communication device which can overcome the above-mentioned problems.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic view of a communication between a first communication device and a second communication device in accordance with an exemplary embodiment.

FIG. 2 is a block diagram of one embodiment of the first communication device which is included in FIG. 1.

FIG. 3 is a flowchart of one embodiment of a communication method of selectively establishing communication between the first communication device and the second communication device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable median include CDs, DVDs, BLU-RAY, flash memory, and hard disk drives.

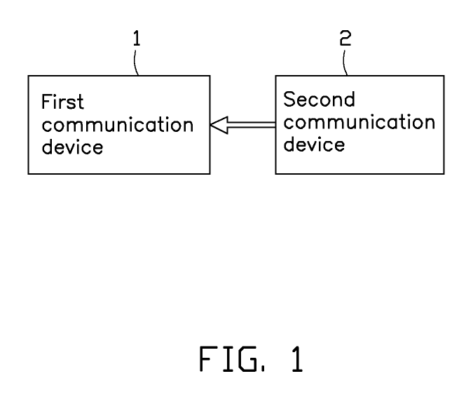

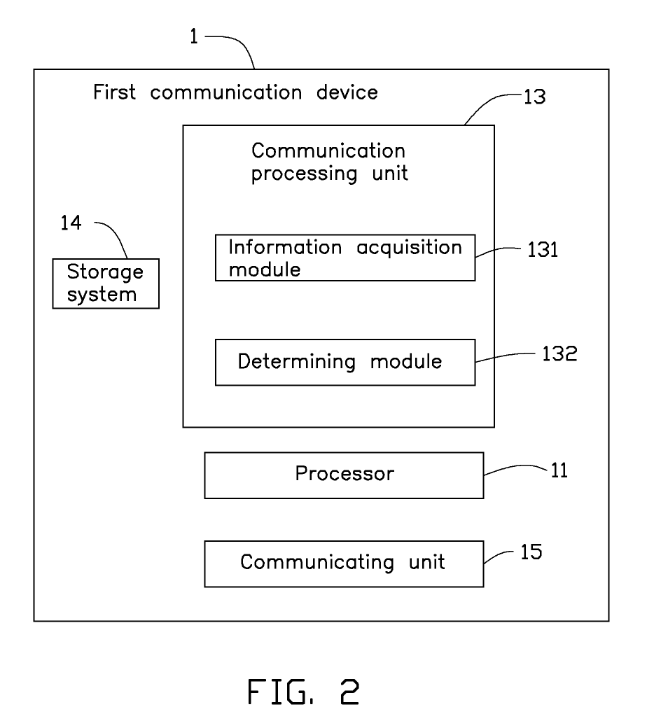

Referring to FIGS. 1 and 2, a first communication device 1 and a second communication device 2, in accordance with an exemplary embodiment, are shown. The second communication device 2 can send a communication request to the first communication device 1. The first communication device 1 is configured for establishing or cutting off communication with the second communication device 2 according to a number of predetermined communication conditions. The first communication device 1 and the second communication device 2 may be, but are not limited to, a mobile phone, a personal digital assistant (PDA), or a tablet personal computer.

In one embodiment, the first communication device 1 includes a storage system 14, a communicating unit 15, at least one processor 11, and a communication processing unit 13. In one embodiment, the communication processing unit 13 includes an information acquisition module 131, and a determining module 132. The modules 131-132 may include computerized code in the form of one or more programs that are stored in the storage system 14. The computerized code includes computer-readable program code (instructions) that are executed by the at least one processor 11 to provide functions for the modules 131-132. The storage system 14 may be a cache or a memory, such as an EPROM, HDD, or flash memory.

The storage system 14 also stores the communication conditions. The communication conditions are inputted by the users through an input interface (not shown) of the first communication device 1. The communication conditions are a number of identification information of a communication device. For example, the communication conditions can be a telephone number of the communication device, an attribution of the telephone number, a personal identification number code (PIN code) of a subscriber identity module card (SIM card) used in the communication device, or a section of the telephone number. In this embodiment, the communication conditions are the identification information of one or more communication devices the user of the first communication device 1 does not want to contact with.

The communicating unit 15 (e.g., antenna) is configured for establishing or cutting off the communication between the first communication device 1 and the second communication device 2.

The information acquisition module 131 acquires one or more identification information of the second communication device 2. In detail, the information acquisition module 131 analyzes the communication request of the second communication 2 to acquire the identification information of the second communication device 2, and transmits the identification information of the second communication device 2 to the determining module 132.

The determining module 132 determines whether the identification information of the second communication device 2 satisfies the communication condition stored in the storage system 14 of the first communication device 1. In this embodiment, the determining module 132 compares the identification information of the second communication device 2 with the communication conditions of the first communication device 1. If the identification information of the second communication device 2 is different from the identification information of the communication conditions, the determining module 132 will generate a permission instruction to control the communicating unit 15 to establish the communication with the second communication device 2. If the identification information of the second communication device 2 is the same as the identification information of the communication conditions, the determining module 132 will generate a prohibition instruction to control the communicating unit 15 to cut off the communication with the second communication device 2.

In an alternative embodiment, the communication conditions are the identification information of one or more communication devices the user of the first communication device 1 wants to contact with. The determining module 132 will generate the permission instruction if the identification information of the second communication device 2 is the same as one of the identification information of the communication conditions. The determining module 132 will generate the prohibition instruction if the identification information of the second communication device 2 is different from the identification information of the communication conditions.

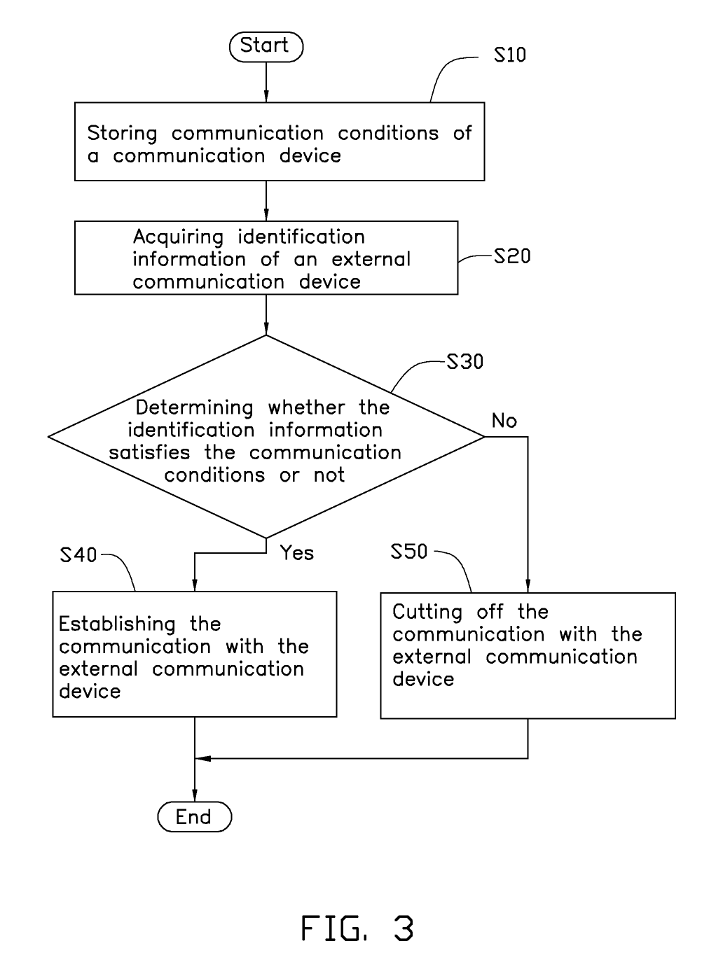

FIG. 3 is a flowchart of one embodiment of a method for selectively establishing or cutting off the communication between the first communication device 1 and the second communication device 2. Depending on the embodiment, additional steps may be added, others deleted, and the ordering of the steps may be changed.

In step 10, the storage system 14 stores a number of communication conditions of the first communication device 1. For example, the communication conditions can be a telephone number of the communication device, an attribution of the telephone number, a personal identification number code (PIN code) of a subscriber identity module card (SIM card) used in the communication device, or a section of the telephone number. In this embodiment, the communication conditions are the identification information of one or more communication devices the user of the first communication device 1 does not want to contact with.

In step 20, the information acquisition module 131 acquires identification information of the second communication device 2 from a communication request sent by the second communication device 2. It is understood that the identification information of the second communication device 2 can be a telephone number of the second communication device 2, an attribution of the telephone number, a personal identification number code (PIN code) of a subscriber identity module card (SIM card) used in the second communication device 2, or a section of the telephone number.

In step 30, the determining module 132 determines whether the identification information of the second communication device 2 satisfies the communication conditions or not. In this embodiment, the determining module 132 compares the identification information of the second communication device 2 with the communication conditions of the first communication device 1. If the identification information of the second communication device 2 is different from the identification information of the communication conditions, the determining module 132 will generate a permission instruction. If the identification information of the second communication device 2 is the same as the identification of the communication conditions, the determining module 132 will generate a prohibition instruction.

In an alternative embodiment, the communication conditions are the identification information of one or more communication devices the user of the first communication device 1 wants to contact with. The determining module 132 will generate a permission instruction if the identification information of the second communication device 2 is the same as one of the identification information of the communication conditions. The determining module 132 will generate a prohibition instruction if the identification information of the second communication device 2 is different from the identification information of the communication conditions.

In step 40, the processor 11 controls the communicating unit 15 to establish the communication with the second communication device 2 according to the permission instruction of the determining module 132.

In step 50, the processor 11 controls the communicating unit 15 to cut off the communication with the second communication device 2 according to the prohibition instruction of the determining module 132.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A communication device, comprising:
a storage system for storing a plurality of communication conditions;
at least one processor;
a communicating unit for establishing or cutting off a communication with an external communication device; and
one or more programs stored in the storage system and being executed by the at least one processor, the one or more programs comprising:
an information acquisition module operable to acquire identification information of the external communication device; and
a determining module operable to determine whether the identification information of the external communication device satisfies the predetermined communication conditions, and control the communicating unit to establish or cut off the communication with the external communication device according to the determination.

2. The communication device of claim 1, wherein the predetermined communication conditions comprise identification information selected from the group consisting of a telephone number of a communication device, an attribution of the telephone number, a personal identification number code of a subscriber identity module card used in the communication device, and a section of the telephone number.

3. The communication device of claim 2, wherein the communication conditions comprise the identification information of one or more external communication devices the user of the communication devices does not want to contact with.

4. The communication device of claim 3, wherein if the identification information of the external communication device is different from the identification information of the communication conditions, the determining module generates a permission instruction to control the communicating unit to establish the communication with the external communication device.

5. The communication device of claim 3, wherein if the identification information of the external communication device is the same as one of the identification information of the communication conditions, the determining module generates a prohibition instruction to control the communicating unit to cut off the communication with the external communication device.

6. The communication device of claim 2, wherein the communication conditions comprise the identification information of one or more external communication devices the user of the communication devices wants to contact with.

7. The communication device of claim 6, if the identification information of the external communication device is different from the identification information of the second group, the determining module generates a prohibition instruction to control the communicating unit to cut off the communication with the external communication device.

8. The communication device of claim 6, if the identification information of the external communication device is the same as one of the identification information of the communication conditions, the determining module generates a permission instruction to control the communicating unit to establish the communication with the external communication device.

9. The communication device of claim 1, wherein the identification information of the external communication device is selected from a group consisting of a telephone number of the external communication device, an attribution of the telephone number, a personal identification number code of a subscriber identity module card used in the external communication device, and a section of the telephone number.

10. A communication method being performed by execution of computer readable program code by a processor of a communication device, the method comprising:
storing a plurality of communication conditions of the communication device;
acquiring identification information of an external communication device;
determining whether the identification information of the external communication device satisfies the communication conditions; and
establishing the communication with the external communication device if the identification information of the external communication device satisfies the communication conditions of the communication device.

11. The method as claimed in claim 10, further comprising: cutting off the communication if the identification information of the external communication device does not satisfy the communication conditions of the communication device.

12. The method as claimed in claim 10, wherein the identification information of the external communication device is selected from the group consisting of a telephone number of the second communication device, an attribution of the telephone number, a personal identification number code of a subscriber identity module card used in the external communication device, and a section of the telephone number.

13. The method as claimed in claim 12, wherein the communication conditions comprise identification information selected from the group consisting of a telephone number of a communication device, an attribution of the telephone number, a personal identification number code of a subscriber identity module card used in the communication device, and a section of the telephone number.

14. The method as claimed in claim 13, wherein the communication conditions comprises the identification information of one or more external communication devices the user of the communication devices does not want to contact with.

15. The method as claimed in claim 14, the identification information of the external communication device is regarded as satisfying the communication conditions if the identification information of the second communication device is different from the identification information of the communication conditions.

16. The method as claimed in claim 13, wherein the communication conditions comprises the identification information of one or more external communication devices the user of the communication devices wants to contact with.

17. The method as claimed in claim 16, the identification information of the external communication device is regarded as satisfying the communication conditions if the identification information of the second communication device is the same as one of the identification information of the communication conditions.

18. A non-transitory computer-readable medium having stored thereon instructions that, when executed by a communication device, the communication device in electronic communication with an external communication device, causing the communication device to perform a communication method, the method comprising:
storing a plurality of communication conditions of the communication device;
acquiring identification information of an external communication device;
determining whether the identification information of the external communication device satisfies the communication conditions; and
establishing the communication with the external communication device if the identification information of the external communication device satisfies the communication conditions of the communication device.

19. The medium as claimed in claim 18, wherein the method further comprising cutting off the communication with the external communication device if the identification information of the external communication device does not satisfy the communication conditions of the communication device.

20. The medium as claimed in claim 18, wherein the identification information of the external communication device is selected from the group consisting of a telephone number of the second communication device, an attribution of the telephone number, a personal identification number code of a subscriber identity module card used in the external communication device, and a section of the telephone number.
